(19) United States
(12) Patent Application Publication
(10) Pub. No.: US 2008/0306708 A1
(43) Pub. Date: Dec. 11, 2008

(54) SYSTEM AND METHOD FOR ORIENTATION AND LOCATION CALIBRATION FOR IMAGE SENSORS

(75) Inventors: Edward M. GERMAIN, IV, McLean, VA (US); David Page, Falls Church, VA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Raydon Corporation, Daytona Beach, FL (US)

(21) Appl. No.: 12/132,423

(22) Filed: Jun. 3, 2008

Related U.S. Application Data
(60) Provisional application No. 60/942,038, filed on Jun. 5, 2007.

(51) Int. Cl. G01B 11/03

(52) U.S. Cl. 702/153

(57) ABSTRACT

A system and method employing position measurement sensors and point sources of light to determine the location and orientation of video cameras in a simulation arena environment. In an embodiment, one or more accelerometers, gyroscopes, and/or magnetometers associated with each video camera may be used to determine the angular orientation of the video camera. The location of a camera is determined by measuring the distance from the camera to at least two known points, where the known points may be point sources of light, other cameras, or a combination thereof. Camera angular orientation information and camera location information may be combined to provide a complete set of data defining the position of each video camera.

### CROSS REFERENCE TO RELATED APPLICATION

This application claims priority to U.S. provisional application “System and Method For Orientation and Location Calibration for Image Sensors”, filed on Jun. 5, 2007, U.S. application No. 60/942,038, which is co-owned with the current application and which is incorporated by reference herein in its entirety as if reproduced in full below.

This application is related to copending U.S. application “Simulation Arena Entity Tracking System”, filed on Nov. 6, 2006, U.S. application Ser. No. 11/593,066 (attorney docket number 2477.0040001), which is co-owned with the current application and which is incorporated by reference herein in its entirety as if reproduced in full below.

### BACKGROUND

1. Field of the Invention

This invention relates to tracking the position and motion of one or more entities in a three-dimensional space, and in particular to calibrating the position(s) of one or more image sensors.

2. Background Art

As understood in this document, a simulation is a physical space in which real people and/or real objects may move, change location, possibly interact with each other, and possibly interact with simulated people and/or simulated objects (whose presence may be enacted via visual projections, audio emissions, or other means) typically in order to prepare for, experience, or study real-life, historical, anticipated, or hypothetical activities or events. Simulations may be conducted for other purposes as well, such as educational or entertainment purposes, or for analyzing and refining the design and performance of mechanical technologies (such as cars or other transportation vehicles, a wide variety of robotic technologies, weapons systems, etc.). The simulation as a whole may also be understood to include any technology which may be necessary to implement the simulation environment or simulation experience.

A simulation may be conducted in an environment known as a simulation arena (or simply as an arena, for short). Realistic simulations of events play a key role in many fields of human endeavor, from the training of police, rescue, military, and emergency personnel; to the development of improved field technologies for use by such personnel; to the analysis of human movement and behavior in such fields as athletics and safety research. Increasingly, modern simulation environments embody simulation arenas which strive for a dynamic, adaptive realism, meaning that the simulation environment can both provide feedback to players in the environment, and can further modify the course of the simulation itself in response to events within the simulation environment. It may also be desirable to collect the maximum possible amount of data about events which occur within the simulation environment, since such data can be used for reporting, analysis, and related purposes.

For a simulation to be adaptive, the technology controlling the simulation arena (where such technology may be a combination of hardware and software) may require information on activity within the simulation environment. A component of this information may be data on the location and movement of people and objects within the simulation environment. A person and/or object within the simulation environment may be referred to generically as a “simulation entity”, or as an “entity”, or the plurals thereof (i.e., “entities”).

The more specific the location data and movement data which may be obtained on simulation entities, the more detailed and refined can be the simulation responses. For example, it is desirable to obtain information not only on where a person might be located, but even more specific information on where the person's hands, head, or feet might be at a given time. A location granularity on the order of feet or meters is highly desirable, and even more fine-grained location discrimination (such as on the order of inches or centimeters) is desirable as well. It is further desirable to be able to determine the orientation in space of people and objects, as well as their rotational motion.

As a consequence, reliable, accurate, and precise location monitoring is a desirable feature of a simulation environment. One means to accomplish this monitoring is video tracking in three dimensions, where one or more cameras may be used to monitor the location and track the movement of entities in the simulation arena. One example of such a simulation arena video tracking system is described in the pending application “Simulation Arena Entity Tracking System”, filed on Nov. 6, 2006, U.S. application Ser. No. 11/593,066. As described in the aforementioned application, determination of the position of entities in the arena environment may be accomplished using video cameras or similar cameras to track entity location and movement.

In turn, to achieve reliable location determination and entity tracking, it is desirable to have specific and detailed knowledge of the location and orientation of the video cameras within the simulation arena. In particular, the use of multiple cameras in an entity tracking environment requires that images of a single entity be accurately correlated from among images provides by multiple video cameras. This, in turn, may require a high degree of resolution of both the location and the angular orientation of each video camera.

However, in the installation of video cameras in the arena environment, there is no guarantee of an exact placement and angular offset. In other words, even though a simulation arena design may indicate a specific placement and orientation of a video camera or cameras, the designated camera location and orientation may not conform with sufficient accuracy to the design specifications.

For example, an arena may be constructed in a conventional space with planar, orthogonal walls. A reference set of spatial coordinates may be established using standard, orthogonal Cartesian coordinates, with the origin of the coordinate system at one corner of the arena space, and with the axes of the coordinate system coinciding with the physical vertices of the walls. In this case, it may prove relatively straightforward to accurately identify the locations of some video cameras, particularly those which are mounted directly on the exterior walls which bound the arena environment, using mechanical measurements, provided the measurements were made with precision and care.

However, it may also be necessary to mount additional monitoring cameras at points on the interior of the arena space, possibly in some cases suspended from various elements of the simulation which themselves may not be entirely structurally stable (e.g., real or artificial trees). Making reliable and accurate measurements of the locations of these interiorly mounted video cameras relative to the arena coordinate system may prove to be problematic.

In addition, it may be beneficial to the simulation to have some cameras mounted on elements of the simulation which are in motion, or even on simulation entities (i.e., simulation participants) themselves. Such mobile video cameras, while helpful to monitoring events within the simulation arena, may need frequent position determination and recalibration.

Further, it is possible that the physical space of the simulation arena does not lend itself to firm, flat, orthogonal walls, or similarly symmetric structures (such as a perfectly cylindrical perimeter wall) which may be convenient for establishing simulation arena coordinates. The walls or perimeter of the simulation arena may be irregular, or the simulation may even be conducted in an outdoor environment. Defining the simulation arena's physical coordinates in these circumstances may prove challenging, which further compounds the challenges of determining the exact location and orientation of cameras used to monitor the simulation.

What is needed, then, is a system and method for easily and reliably determining the orientation and location of cameras in a simulation arena.

### SUMMARY

The current invention improves on camera tracking technology by providing a solution to measuring the mounting position of a video camera. This system may be used with any number of cameras. By accurately calibrating the positions of multiple cameras, it becomes possible to correlate tracked objects between views provided by different cameras. The invention is composed of three main components that work together to provide substantially accurate orientation/location measurements.

The first of these elements is the position measurement device (PMD). In one embodiment, the position measurement devices comprise a three-axis accelerometer and a two-axis magnetometer.

The second component comprises one or more image sensors. In one embodiment, an image sensor may be a black-and-white CMOS video camera with an infrared filter attached.

The third component comprises one or more known tracking point sources (TPSs). In one embodiments, the known tracking point sources are infrared light emitting diodes (LEDs), where the infrared light is in the spectra visible to the image sensors. When a TPS is used to calibrate the location of image sensors, the TPS may also be known as a calibration point source (CPS).

The system is calibrated by measuring the mounting angle of each camera with a position measurement device (PMD). Then, the distance to two or more known CPSs, or to two or more known cameras, or to a combination of two or more known CPSs and/or known cameras is measured. With these measurements, the location of each camera can be resolved.

### BRIEF DESCRIPTION OF THE DRAWINGS/FIGURES

The features and advantages of the present invention will become more apparent from the detailed description set forth below when taken in conjunction with the drawings in which like reference numbers indicate identical or functionally similar elements.

Additionally, the left-most digit of a reference number identifies the drawing in which the reference number first appears (e.g., a reference number ‘310’ indicates that the element so numbered first appears in FIG. 3). Further, elements which have the same reference number followed by a different letter of the alphabet or other distinctive marking (e.g., an apostrophe) indicate elements which may be the same or substantially similar in structure, operation, or form, but may be identified as being in different locations in space or recurring at different points in time.

FIG. 1 illustrates an arena where simulation event takes place, and where energy-emitting tracking point sources (TPSs) attached to entities (people or objects) may be used to monitor entity motion in the arena; and also where the TPSs, some of which are calibration point sources (CPSs), also may be used to help calibrate the position of image sensors in the arena.

FIG. 2 illustrates a system for orientation and location calibration for image sensors.

FIG. 3 illustrates in detail the calculations involved when a single image sensor calibrates its orientation and location in the arena by imaging two CPSs.

FIG. 4A illustrates that when an image sensor images a single CPS, a determination may be made that the image sensor is located somewhere along the surface of a sphere in space.

FIG. 4B illustrates that when an image sensor images two CPSs, a determination may be made that the image sensor lies somewhere along a specific circle in space.

FIG. 5 illustrates the determination of a line in space between a CPS and an image sensor, as a means of further resolving the location of the image sensor.

FIG. 6 illustrates the determination of the location in space of an image sensor based on both a previously determined circle of possible locations and a pair of previously determined lines of location.

FIG. 7A and FIG. 7B together illustrate an approach for identifying an angle of incidence of light, on an image sensor backplane, of light coming from a CPS.

FIG. 8 illustrates representative front and side views of an image sensor with a built-in, front mounted CPS.

FIG. 9 illustrates an exemplary computer system configured to run software suitable for the present system and method.

Further embodiments, features, and advantages of the present invention, as well as the operation of the various embodiments of the present invention, are described below with reference to the accompanying figures.

### DETAILED DESCRIPTION

One or more embodiments of the present invention are now described with reference to the figures. While specific configurations and arrangements are discussed, it should be understood that this is done for illustrative purposes only. A person skilled in the relevant art(s) will recognize that other configurations and arrangements can be used without departing from the spirit and scope of the invention. It will be apparent to a person skilled in the relevant art(s) that this invention can also be employed in a variety of other systems and applications.

A list of the major sections of this detailed description follows:

### 1. Definitions and Characterizations of Elements and Technologies Which May Be Employed In or Related to The Present Invention

### 2. The Simulation Arena Environment

### 3. A System For Determining The Location Of An Image Sensor

### 4. A Method For Determining The Location Of An Image Sensor

### 5. Determining the Angle of Incidence of Light On the Image Sensor Backplane

### 6. Eliminating Skew Errors

### 7. Visual Tracking Systems With Two Or More Cameras

### 8. Image Sensors, the Arena Data Analysis Engine, and Data Processing Elements

### 9. Summary

1. Definitions and Characterizations of Elements and Technologies which May be Employed in or Related to the Present Invention

Simulation arena or simulation environment—The term “arena” has already been discussed above in some detail. Briefly and in general terms, the arena is the physical space in which a simulation is conducted. The terms “simulation environment”, or simply “environment”, may be taken somewhat more broadly to include both the physical space used by the simulation (i.e., the arena proper) and also the various technologies and other elements which contribute to the simulation experience. However, such terms as “simulation arena”, “simulation environment”, “arena environment”, and similar combinations of terms may be used interchangeably in this document where the context of the discussion makes the scope of the phrase apparent.

Entity—A person, other living being, or object within a simulation arena, typically excluding some, most, or all of the infrastructure objects or technologies used to enable the simulation process itself (e.g., excluding lighting fixtures; fixed, stationary structures; image sensors; tracking point sources; cabling, etc.). Entities are generally the living beings and/or physical objects which are, in the art, viewed as players or participants in the simulation, and whose locations and/or movements may be tracked during the course of the simulation.

Visual tracking system—A system used to determine the location of entities, which are typically entities within a simulation arena. A visual tracking system may comprise a single image sensor, or may comprise multiple image sensors (i.e., an image sensor array), wherein the image sensor or image sensors detect entities within their field of view. A visual tracking system may further comprise a means for analyzing and/or integrating location data provided by one or more image sensors; the means may be a computer (e.g., a desktop computer or laptop computer), a microprocessor, a data analysis engine (DAE), or other data processing technology or system.

Image sensor—Except where otherwise noted, the following terms are used synonymously throughout this document: image sensor, camera, video camera, visual tracking device (VTD), energy detection device, and the respective plurals thereof. All such terms may be understood as referring to a device that may encompass at least the capabilities for obtaining a time-series of images as typically embodied by a standard video camera. That is, an image sensor may be understood as referring to a device which captures light energy in a field of view, and which focuses the light energy on an image detecting element or image plane, thereby detecting a series of images over time for the purpose of detecting and capturing the location or movement of objects in the field of view of the image sensor. An image sensor may detect a series of images at a typical frame rate on the order of tens of image frames per second.

However, it should be further understood that an image sensor may embody other capabilities or modified capabilities as well. These capabilities may include, for example and without limitation, the ability to obtain image data based on energy in the infrared spectrum or other spectral ranges outside of the range of visible light; the ability to modify or enhance raw captured image data; the ability to perform calculations or analyses based on captured image data; the ability to share image data or other data with other technologies over a network or via other means; or the ability to emit or receive synchronization signals for purposes of synchronizing image recording, data processing, and/or data transmission with external events, activities, or technologies.

Other enhanced capabilities, adaptations, or modifications of an image sensor as compared with a standard video camera may be described further below in conjunction with various embodiments of the present invention. In one embodiment, an image sensor may be a black-and-white CMOS video camera with an infrared filter attached.

Camera comprised of multiple image sensing units—In some cases, it may be specifically indicated that a single camera, single video camera, or single image sensor may be comprised of two or more discrete image sensing units. Typically, such a video camera employs the two discrete image sensing units as a means to provide stereoscopic imaging, i.e., imaging with depth information.

Positional measurement device (PMD)—The following terms may be used synonymously throughout this document: positional measurement device, PMD, orientation measurement device, orientation measuring device, orientation sensing device, orientation sensor, angular orientation measurement device, angular orientation measuring device, angular orientation sensing device, angular orientation sensor, and the respective plurals thereof. All such terms may be understood as referring to a class of technologies which can determine, in part or in whole, an angular orientation of an object or entity relative to some designated angular frame of reference.

Positional measuring devices (PMDs) may include accelerometers, magnetometers, gyroscopes, or other orientation sensors. An accelerometer can measure the direction of the gravity vector to determine positional angles. A magnetometer can measure the direction of a localized magnetic field or Earth's magnetic field. A gyroscope can measure angle of tilt off of level.

Tracking point source (TPS)—The following terms may be used synonymously throughout this document: point source, tracking point source, TPS, source of energy emission, energy emitting device, and the respective plurals thereof.

A tracking point source may be understood as an energy emitting device which is physically small compared to the physical size of a typical entity in the simulation. The actual energy-emitting component itself, which may be only one component of the tracking point source, may be small enough to be considered as substantially a point source of light. The energy emitted by the TPS may be infrared light, or possibly light in some other frequency range. The light emitted by the TPS falls in a frequency range which can be detected by the image sensors used in the simulation arena. In one embodiment of the present invention, the image sensors may be limited to sensing light emissions in an energy range beyond human perception (e.g., 780-960 nm), and hence the light emitted by the tracking point sources (TPSs) would fall in this range as well.

A TPS will at a minimum be comprised of an element or component (already referred to above) for emitting electromagnetic energy, a means for powering the electromagnetic energy-emitting component, and possibly a means for modulating the emissions of the electromagnetic energy-emitting component. One or more TPSs may be attached to each entity in the simulation arena, and used to track the movement of the simulation entities. For this purpose, a TPS may be able to modulate its energy emissions in a distinctive pattern in order to uniquely identify a simulation entity.

Each TPS may internally store its identity, i.e., the unique modulation pattern for its energy emission, and may possess a means for said storage such as an internal memory chip. A TPS may have a hard-coded, fixed modulation pattern, or a TPS may be programmable to upload different modulation patterns. In turn, this identity (that is, the unique modulation pattern) may be registered with a system which integrates data from multiple TPSs or which controls the overall operation of the simulation (for example, with a data analysis engine (DAE)), prior to the start of operations of a simulation. One example of such a TPS modulation system is described in the copending application “Simulation Arena Entity Tracking System”, filed on Nov. 6, 2006, U.S. application Ser. No. 11/593,066, which is co-owned with the current application and which is included here by reference in its entirety.

Calibration point source (CPS)—For purposes of the present invention, one or more TPSs may not be attached to a simulation entity. Instead, one or more TPSs may be attached to one or more respective fixed locations in the simulation arena, for purposes of establishing fixed, known locations in the arena which may be detected by the image sensors. These TPSs which are attached to respective fixed, known locations may be used to help determine the location of the image sensors, i.e., to calibrate the image sensor locations, as discussed further below.

These TPSs which are used to help calibrate image sensor location and/or orientation may be identical or substantially the same in structure and internal function as TPSs which are used for entity tracking, or there may be some differences in structure or internal function. In particular, those TPSs which are used to help calibrate image sensor position may still employ a system of assigning a unique modulation scheme to each TPS, which may be the same as or similar to the system used to assign modulation patterns to TPSs which are attached to entities, or which may be a different system of modulating the TPSs.

A TPS or TPSs which is/are fixed in place for the purpose of identifying or calibrating the location of one or more image sensors will be known as a “calibration point source”, or a “CPS”, or the plurals thereof, irrespective of whether such a TPS is or is not the same in structure or the same in internal function as a TPS which is used to determine entity location.

CPS-enhanced Sensor (CPSES)—A sensor may have an integrated CPS, where a light emitting element is attached or embedded somewhere on one of the external, visible surfaces of the image sensor, so that it may serve as a reference light source for other image sensors during the calibration process. An image sensor with an integrated CPS may be referred to as a CPS-enhanced sensor, or as a CPSES for short, the plural being “CPSESs”.

Location, orientation, and position—The location of an image sensor may be defined as a set of coordinates, typically in three dimensions, which determine a vector, wherein the tail of the vector coincides with the origin of a designated arena coordinate system, and the head of the vector coincides with the image sensor. More particularly, the head of the vector may coincide with a specific point located on or within the image sensor, such as the center of the image sensor's image plane.

The orientation of the image sensor may be defined as the angular bearing of the image sensor in relation to a set of coordinate axes of the designated arena coordinate system.

Finally, the position of the image sensor may be defined as an aggregate concept, and as a combined set of coordinates, which indicate both the location and orientation of the image sensor in relation to the designated arena coordinate system.

In conventional and somewhat informal language, the location indicates where the image sensor is; the orientation indicates which way the image sensor is facing; the position indicates both where the sensor is and which way the image sensor is facing.

Calibration—Calibration is a method or process of determining the location and/or the orientation of the image sensor (that is, of determining the position of the image sensor).

### 2. The Simulation Arena Environment

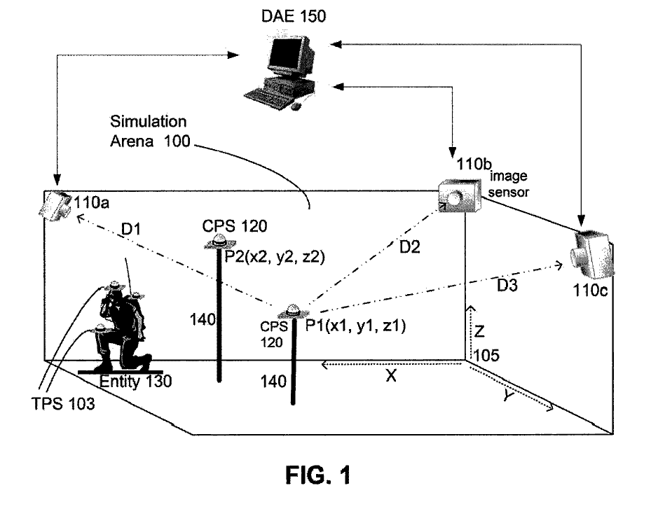

FIG. 1 illustrates an arena 100, which may be defined as a bounded region of space which may be either indoors or outdoors, with one or more image sensors 110 which may be conventional video cameras or other image sensors. While only one image sensor 110 may be used, in many instances it may facilitate effective entity tracking to employ more than one image sensor 110. Some of the discussion below is based on an assumption that a plurality of image sensors 110 are being used in the arena.

Image sensors 110 are mounted in such a way that each one of the image sensors 110 has a field of view which at least partially overlaps with the field of view of at least one other of the plurality of image sensors 110. These image sensors 110 are the visual tracking devices (VTDs) which monitor the position of entities 130 in the simulation arena 100. The image sensors 110 may be mounted in the periphery, or the interior, or both the periphery and interior, of a bounded volume of space to be monitored.

FIG. 1 illustrates an exemplary embodiment only, in which only three image sensors 110 are in use. More or fewer image sensors 110 may be used, and the locations of the image sensors are not limited to the upper corners of an arena 100.

The arena 100 is generally understood as the bounded volume of space wherein a simulation or gaming event may be conducted. The boundaries of the bounded volume of space may be defined by walls or other delimiters or markers, and substantially all or most of the bounded volume of space will be monitored by the plurality of image sensors 110. However, the arena 100 may also be understood to be defined topologically as the set of all points which are visible to two or more image sensors 110, since at least two image sensors 110 may be needed to identify the location of an entity 130 in the arena.

An arena 100 may be created for the purposes of establishing an environment for human training or human event simulation, or for the testing of technologies which may be directly human controlled, remote controlled, or entirely automated, or for other purposes. Although not directly salient to the present invention (i.e., not directly salient to a system and method for determining the orientation and location of image sensors in the arena), an exemplary entity 130 is illustrated in FIG. 1, with several TPSs 103 attached.

FIG. 1 also shows how an exemplary coordinate system 105 may be imposed upon the arena 100 for the purpose of identifying the location of TPSs 103 and CPSs 120 (discussed further immediately below) within the arena. The locations of the image sensors 110 may also be identified in relation to this same coordinate system. A conventional Cartesian coordinate system 105 with three orthogonal coordinate axes (x, y, z) is illustrated, with its origin at one corner of the arena; however, other coordinate systems may be used including, for example and without limitation, a spherical coordinate system or a cylindrical coordinate system.

A special-purpose class of TPSs is also shown in FIG. 1. Specifically, FIG. 1 shows two TPSs 120 at respective separate locations P1 and P2, with respective spatial coordinates (x1, y1, z1) and (x2, y2, z2). The TPSs 120 illustrated at points P1 and P2 are not attached to simulation entities, and hence are not used for tracking the location of simulation entities. Rather, they are located at the known, fixed locations P1 and P2, and may be used to assist in determining the locations of image sensors 110. In FIG. 1 the two TPSs 120 are shown as mounted on vertical poles 140, but this is for purposes of illustration only. TPSs 120 may be attached to walls, floors, or ceilings, may be suspended from the ceiling, may be attached to other fixed elements within the simulation environment, or may in other ways be to attached or held in place at fixed, identified, known locations within the simulation arena environment.

As noted above, a TPS or TPSs which is/are fixed in place for the purpose of identifying or calibrating the position of one or more image sensors will be known as a “calibration point source”, or “CPS”, or the plurals thereof. The “CPS” terminology will be used henceforth.

For the method of the present invention to work, the locations of the CPSs 120 must first be established. In one embodiment of the present invention, the location of the CPSs 120 may be determined by first attaching each CPS 120 to fixed location within the arena environment, and then using a variety of conventional measurement methods to determine the locations of the CPSs 120. These measurement methods may include, for example and without limitation, determining distance from an origin point and/or distance from one or more coordinate axes using rulers, tape measures, or similar mechanical means; laser range measuring; RF signal timing measures; and other means well known in the art.

In an alternative embodiment of the present invention, some CPSs 120 may be physically attached to or be part of one or more image sensors 110. The location of some CPSs 120 may be determined in part by the means indicated immediately above; whereas for other CPSs 120, particularly those which are attached to image sensors 110, their locations become known as the locations of their associated image sensors are determined through the methods indicated below.

For the present system and method to be operational, each CPS 120 must be at a fixed, known location within arena 100 which is separate from the fixed, known location of the other CPSs 120. A preferred minimum separation distance between any given pair of CPSs 120 will depend on several specific factors. CPSs 120 must be located close enough that any given sensor 110 has at least two CPSs 120 in view, and generally having additional CPSs 120 in view of a sensor 110 may increase the accuracy and reliability of the location determination process. At the same time, to provide maximum accuracy and reliability, CPSs 120 should be spaced as far apart as possible while still being within the field(s) of view of a sensor or sensors 110. The preferred spacing between CPSs 120 will therefore be contingent on such factors as the size of arena 100, the numbers of CPSs 120 employed, the angular field of view of sensors 110, and the approximate anticipated distance (or range of distances) which may occur between sensors 110 and CPSs 120. The spacing may also vary in different parts of arena 100. In some instances, sensors 110 may be expected to be mobile (and therefore be at time-varying distances from CPSs 120). In such cases, CPSs 120 may be deployed at relatively close spacing or more densely, it being understood that sensors 110 may have different numbers of CPSs 120 in their field of view depending on the locations of sensors 110.

FIG. 1 also illustrates a data analysis engine (DAE) 150, which is a computer or analogous computational device or centralized processing unit which integrates and analyzes data from the image sensors 110 to determine the motion of entities 130 within the arena. DAE 150 may also support the calculations required for the location calibration and orientation calibration of the image sensors. DAE 150 may be networked to both the image sensors 110 and to an arena host computer system (not shown). The DAE 150 may be local to each arena if there are multiple arenas in use.

It may be that most or all of the computational tasks of the present invention are performed by the DAE 150, though some may be offloaded to other elements, such as other computation systems or devices other than DAE 150, or performed in the image sensors 110 themselves.

Finally, illustrated in FIG. 1 are straight lines D1, D2, D3 which extend from a CPS 120 to respective image sensors 110a, 110b, and 110c. Each line may be thought of as a ray of light extending from the point source of light, namely, a CPS 120, to the aperture of an images sensor 110. Each line or ray of light is labeled with the letter ‘D’ (D1, D2, etc.) for ‘distance’, to indicate that the line extends for a certain distance, or length. As will be discussed in detail below, in order to determine the location of the image sensor 110, it may be necessary to first determine the distance from one or more CPSs 120 to the image sensor 110.

### 3. A System for Determining the Location of an Image Sensor

In visual tracking systems, in order to enable various positional calculations which will be made during the progress of the simulation run itself, an image sensor needs to be calibrated to a local coordinate system (such as, for example, the conventional Cartesian x-y-z coordinate system 105 of FIG. 1) associated with the arena. Calibration entails determining both the orientation and location of the image sensor in relation to the designated coordinate system.

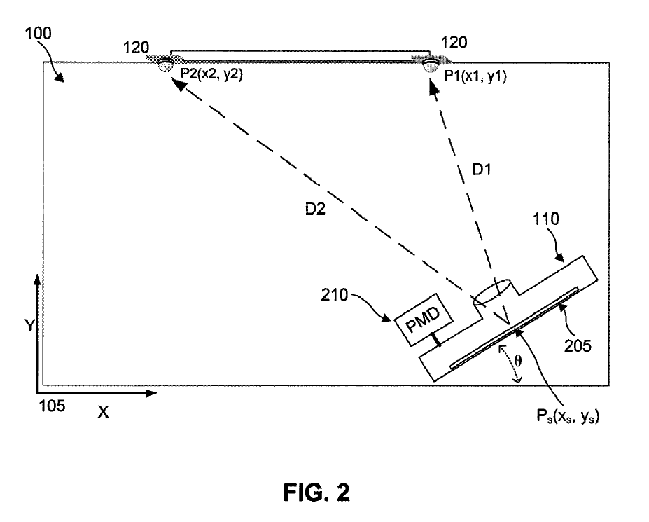

FIG. 2 illustrates a system for calibrating the position of an image sensor. In an exemplary embodiment, the system requires:
a defined arena coordinate system 105;
the image sensor 110 itself, including in particular the image sensor imaging element or backplane 205;
at least two CPSs 120 at known, fixed positions P1 and P2;
a means 210, such as a PMD 210, for determining the angular orientation θ of the image sensor 205 in relation to the arena coordinate system 105.

By means of these elements, it is possible to determine the distances D1, D2 from image sensor 110 to the CPSs 120, as will be discussed further below. As also discussed further below, with D1 and D2 determined, it is possible to further determine the location Pₛ(xₛ, yₛ) of image sensor 110.

It should be noted that, for simplicity of illustration and exposition, only two dimensions are shown in FIG. 2, and correspondingly limited coordinates (two spatial coordinates, one angular coordinate) are presented here. Persons skilled in the relevant art(s) will recognize that the system shown, and corresponding location coordinate and angular measurements, can readily be extended to three dimensions. In the discussion below, a more limited set of coordinates (i.e., two-dimensional coordinates) may be employed when referring specifically to the figures which illustrate the present system and method; while a full set of three-dimensional coordinates may be employed when referring to the present system and method in a more general embodiment.

In an exemplary embodiment of the present invention, a first step in sensor position calibration entails determining the orientation of the image sensor. For example, the image sensor orientation may be measured using a positional measurement device (PMD). FIG. 2 illustrates an image sensor 110 with an associated PMD 210. In an exemplary embodiment the PMD 210 may be comprised of a combination of accelerometers and gyroscopes (not shown) combined on a single platform. PMD 210 may also be composed only of one or more accelerometers, or one or more gyroscopes, or other means for determining the angular orientation of image sensor 110.

The PMD 210 may be a separate unit, which is then attached to the image sensor 110 (for example, attached to the camera's base); or the PMD 210 may be integrated into image sensor 110.

PMD 210 provides data necessary to determine the camera's angular orientation relative to a coordinate system 105. For example, if the arena 100 has flat orthogonal walls, the physical layout may readily lend itself to a coordinate system employing Cartesian coordinates with axes aligned with the physical vertices of the arena 100 environment. An exemplary set of such coordinate axes 105 are shown aligned with the borders of arena 100 in FIG. 2. For simplicity only two dimensions are shown, along with only two orthogonal Cartesian axes (x and y) and one angle (θ) for the angular orientation of image sensor 110 in relation to the Cartesian axes; persons skilled in the relevant art(s) will readily appreciate that the coordinate system may be extended to three dimensions, along with the coordinates used to specify the orientation of the camera (e.g., θ, ψ, ξ); and further, that other coordinate systems (e.g., polar, cylindrical, spherical, or other systems) may be used. Below, the single symbol θ is sometimes employed to refer to the angular orientation of image sensor 110, it being understood that in practice two or three angular coordinates may be required. Similar, the pair of coordinates (x, y) may be used to designate a location in space (whether of a CPS or the image sensor), it being understood that three spatial coordinates (for example, (x, y, z)) may be required in practice.

A common set of known points P1, . . . , PN within the field of view of the single image sensor provides known ordinal coordinates. These known points may be marked, delineated, or established by CPSs 120, as described above; or by other image sensors with already established locations, and with onboard point light sources (i.e., onboard CPSs); or by a combination of both.

Using the known positions of the points P1, P2, and other points if available, plus the angular orientation θ of the image sensor 110, it is possible to determine the distances D1 and D2 from the image sensor 110 to each of the points P1, P2. Since the locations of P1 and P2 are known, with distances D1 and D2 known as well, it is possible to determine the coordinates Pₛ(xₛ, yₛ) of the image sensor 110 itself through calculations discussed further below.

### 4. A Method for Determining the Location of an Image Sensor

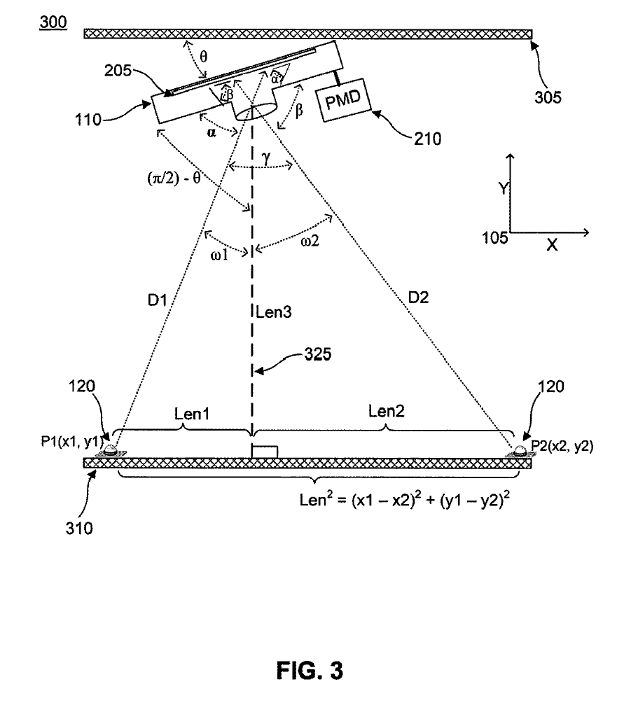

FIG. 3 illustrates in more detail an exemplary method of determining the distances D1 and D2 from the camera 110 to the CPSs 120. For convenience and simplicity, FIG. 3 shows the process in only two dimensions, but persons skilled in the relevant art(s) will recognize that the calculations illustrated and discussed further below can readily be generalized to three dimensions.

Also, for relative simplicity of illustration and exposition, FIG. 3 shows two CPSs 120 attached to one wall 310 of arena 100, and image sensor 110 attached to the opposing wall 305, though partly offset from wall 305 by an angle θ. (It may be supposed, for example, that image sensor 110 is attached to wall 305 via a hinged attaching device [not illustrated].) Walls 305 and 310 are also illustrated as being parallel to each other. Further, the simplified schematic view of the image sensor 110, as illustrated, suggests a camera backplane or imaging element which is parallel to a lens or other focusing element (not shown).

Again, the relative symmetry of the arrangement (such as the parallel walls 305, 310) simplifies the exposition of the method below, but persons skilled in the relevant art(s) will recognize that the method of the present invention, with the same, similar, or substantially analogous calculations, can be carried out even if the CPSs 120, walls 305, 310, and/or camera 110 are arranged with significantly different spatial relations. Similarly, persons skilled in the relevant art(s) will recognize that the methods and calculations disclosed below may be adapted to an image sensor with a significantly different internal geometry or internal architecture than that suggested by FIG. 3. (For example, the method may be adapted to an image sensor wherein the backplane or imaging element is not parallel to a lens or other light focusing element, or where internal mirrors or other optical elements may significantly redirect the path of the light entering the image sensor.)

In an exemplary embodiment of the present method, the location of image sensor 110 can be determined provided the following parameters are established or can be measured:

(1) A coordinate system 105 for elements within the arena 100, which is hence known as the arena coordinate system.

(2) The position of at least two known points P1 and P2 in the arena 100, with their position defined relative to the arena coordinate system 105, and wherein the two known points P1 and P2 are within the field of view of the image sensor 110. Various means for initially determining the locations of known points P1 and P2 have already been discussed above.

(3) A means for the image sensor 110 to obtain an image of the two known points P1 and P2. As already discussed above, this may be accomplished by fixing CPSs 120 at points P1 and P2, or by other means.

(4) The angular separation γ between the points P1 and P2, relative to the image sensor 110. In an exemplary embodiment of the present invention, an equivalent determination are the respective angles of incidence α, β on a backplane 205 of image sensor 110 of rays of light D1, D2 from CPSs 120 located at respective points P1, P2.

(5) The angular orientation θ of image sensor 110 relative to the arena coordinate system 105. This is determined by PMD 210 attached to image sensor 110.

Determining the Distance from the Image Sensor to Known Points

In an exemplary embodiment of the present invention, the angular separation between points P1 and P2, relative to image sensor 110, can be measured with image sensor 110. Specifically, rays of light D1, D2 from CPSs 120 strike backplane 205 of image sensor 110 at angles α and β, respectively. A method by which image sensor 110 may make an angular determination of α and β is described further below.

With α and β determined by image sensor 110, the angular separation γ between rays of light D1, D2 can be found from:

γ=π−(α+β)

where the symbol “π” is equivalent to an angular measure of 180°. Referring again to FIG. 3, it is also desired to know the linear distance Len between P1 and P2. Recalling that positions P1(x1, y1) and P2(x2, y2) are known positions, this can be calculated as:

Len²=(x1−x2)²+(y1−y2)²

Len is determined by taking the positive square root of Len².

In order to determine the position of image sensor 110 relative to points P1, P2, it is desired to know the distances D1 and D2. Given Len, the linear distance between P1 and P2, all that is necessary to know is:
the angle ω1, which is the angle between line D1 and line 325, where line 325 is the perpendicular extending from image sensor 110 down to the line joining P1 and P2 (i.e., line 325 intersects, at a right angle, the line joining P1 and P2); and
the angle ω2, which is the angle between line D2 and line 325.

Referring to the angles defined in FIG. 3, the following calculations follow:

ω1=(π/2)−(α+θ)

where α is determined by image sensor 110 as discussed briefly above and in more detail below, and θ is determined by PMD 210,

ω2=γ−ω1

where γ=π−(α+β) as noted above, and α, β are determined by the image sensor 110 as discussed briefly above and in more detail below.

Further calculations yield:

Len1=Len*tan(ω1)/[tan(ω1)+tan(ω2)]

Len2=Len−Len1

And finally:

D1=Len1/sin(ω1), and

D2=Len2/sin(ω2)

In an alternative embodiment of the present invention the image sensor may be stereoscopic, that is, comprised of two image sensing units separated by a known distance along a parallel axis orthogonal to the viewing plane; this allows for distance determination (i.e., determination of D1 and D2) using algorithms which are well-known in the art. Such stereoscopic imaging means of determining D1 and D2 may be used as an alternative to the method described immediately above; such stereoscopic imaging means of determining D1 and D2 may also be used to complement the method or substantially similar methods to the one described above, as a means of error checking, or to obtain greater precision in the determination of D1 and D2. For example, a more reliable means of determining D1 and D2 may be to take, for each distance, an average or a weighted average of the distance as determined by the angular measurements described above, and the distance as determined by stereoscopic imaging.

As noted above, the methods described above for determining the distances D1, D2 from image sensor 110 to respective known points P1, P2 can be readily generalized to three dimensions, wherein the orientation of image sensor 110 may be characterized by three angles (θ, ψ, ξ), and the position of each known point in space (determined by CPSs 120) may be characterized by three coordinates such (x, y, z) or other systems of three-dimensional spatial coordinates, depending on the coordinate system 105 employed. Further, in a three-dimensional embodiment, the angles of incidence of rays of light D1, D2 on the backplane 205 of image sensor 110 may be characterized by pairs of angles, e.g., (α1, α2) for D1 and (β1, β2) for D2.

It will be further recognized by persons skilled in the relevant art(s) that the methods described above to identify distances D1, D2 from image sensor 110 to known points P1(x1, y1, z1), P2(x2, y2, z2) may be extended to determining distances D3, D4, . . . , DN for distances from image sensor 110 to known points P3(x3, y3, z3), P4(x4, y4, z4), . . . , PN(xN, yN, zN).

### Image Sensor Location Determination

The position of the image sensor may be defined as Pₛ(xₛ, yₛ, zₛ) which, in an exemplary embodiment, may be the position of the focal point of the image sensor 110 image plane 205. Equations for the position of the image sensor may then be derived of the form:

(xₛ−x1)²+(yₛ−y1)²+(zₛ−z1)²=D1²

. . .

(xₛ−xN)²+(yₛ−yN)²+(zₛ−zN)²=(DN²

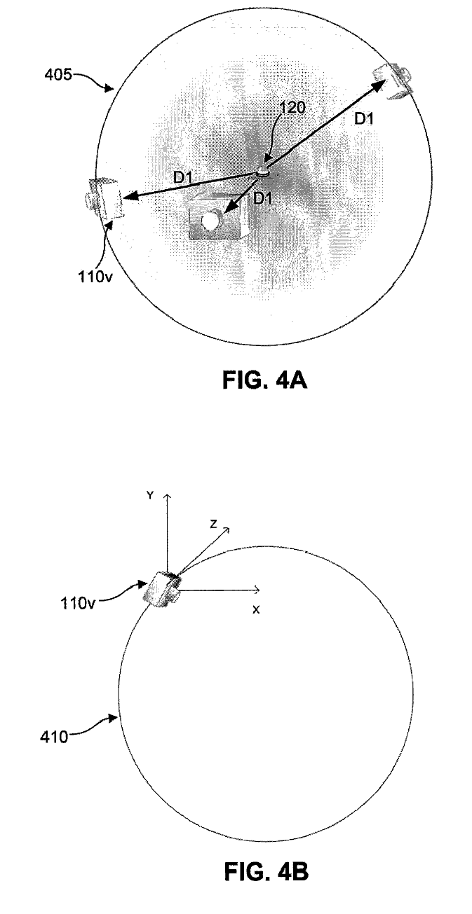

Each of these equations may be recognized as standard equations for spheres, wherein each sphere S1, . . . , SN is centered around a respective known point P1(x1, y1, z1), . . . , PN(xN, yN, zN); unknown point Pₛ(xₛ, yₛ, zₛ), i.e., the unknown location of the image sensor 110v, is located somewhere on the surface of the sphere. This is illustrated in FIG. 4A, where the multiple image sensors 110v on the surface of sphere 405 are shown as partly transparent, indicating that they all represent “virtual” image sensors at potential locations of the actual image sensor. Note that all of these virtual image sensors 110v are at the same distance D1 from CPS 120. Further note that image sensor 110v may be anywhere on the surface of sphere 405; the three locations illustrated are exemplary only.

At a minimum, at least two known points P1, P2 must be in the field of view of the image sensor. In this case (i.e., only two known points are in the field of view), a joint solution of the two resulting sphere equations is an equation of a circle 410 in three-dimensional space. Image sensor 110v lies somewhere along circle 410, as shown in FIG. 4B.

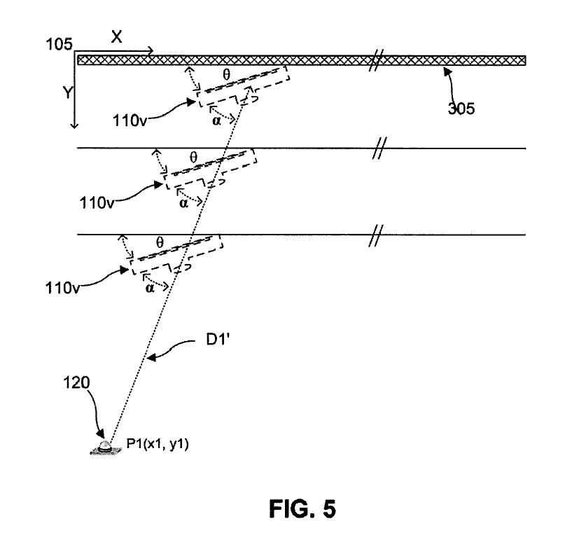

FIG. 5 illustrates in part a method by which the exact location of the image sensor 110 may be further resolved. Specifically, the method entails determining the equation of a line extending from image sensor 110 to CPS 120.

In an exemplary embodiment of the present invention, PMD 210 associated with image sensor 110 can provide the mounting angles (θ, ψ, ξ) of image sensor 110 in relation to arena coordinate system 105. Moreover, image sensor 110 provides the two-dimensional angles of incidence (α1, α2) on the backplane 205 of image sensor 110 of the ray of light D1 from CPS 120 at a point P1. (This angular determination of the angle of incidence of rays of light on backplane 205 is discussed further below.)

For simplicity of illustration FIG. 5 illustrates two dimensions only, showing only a representative camera orientation θ and a representative angle of light incidence α. Similarly, only two dimensions (x, y) are illustrated for P1, using a Cartesian x, y coordinate system. Ray of light D1′ is annotated with the apostrophe to indicate that for the current calculations, we are determining only a direction of the line and not a distance.

Using the parameters shown in FIG. 5, the two dimensional equation for the line (i.e., the ray of light) D1′ extending from P1 at known position (x1, y1), and consistent with the known image sensor-related angles θ and α as illustrated, is given by:

y−tan(θ+α)*x=y1−tan(θ+α)*x1

. . . where, since y1, x1, θ and α are known values, the expression on the right-hand side of the equation (i.e., y1−tan(θ+α)*x1) can be calculated to yield a constant value.

Similarly, it will be apparent to persons skilled in the relevant arts that in three dimensions, using known image sensor mounting angles (θ, ψ, ξ), known angles of light incidence (α1, α2), and the known position (x1, y1, z1) of point P1, it is possible to determine the numeric values of parameters a, b, c, and d to define a three-dimensional camera/known-point line D1′ represented by the linear equation:

ax+by+cz=d

As illustrated in FIG. 5 by the several exemplary “virtual” image sensors 110v (wherein the virtual image sensors have dotted-line boundaries), the actual image sensor 110 must lie somewhere along line D1′.

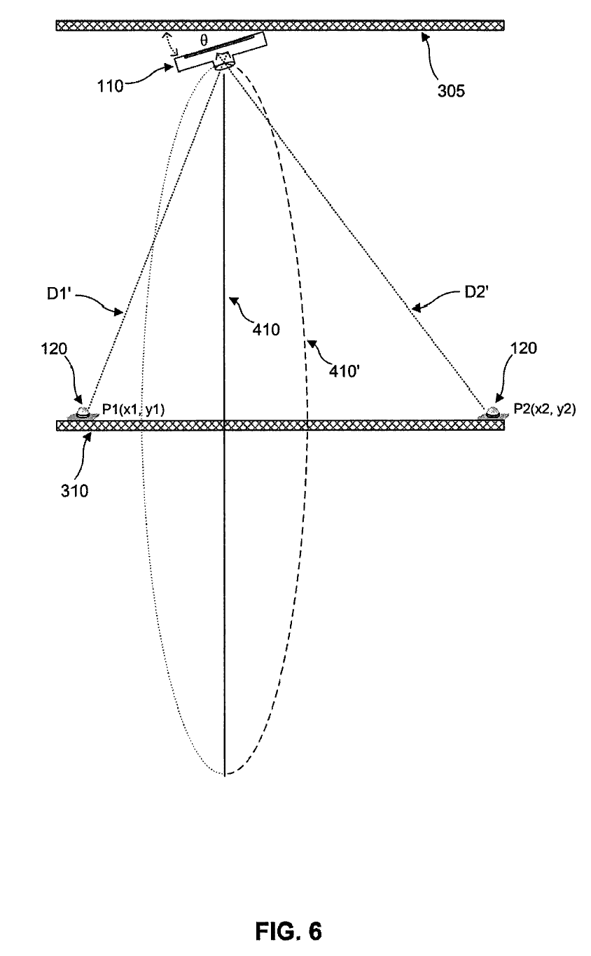

FIG. 6 as drawn is assumed to be a top-down view of an essentially two-dimensional arena space, where P1, P2, and image sensor 110 are assumed to be co-planar (for example, all three on the floor of arena 100, or all three on the ceiling of arena 100.) From this perspective, circle 410 would be orthogonal to the plane of the drawing, and is therefore drawn as it would actually be seen from this perspective, namely as line 410. Dotted oval 410′ is presented as an aid to visualization of circle 410, indicating circle 410 extending into and out of the plane of the figure.

As illustrated in FIG. 6, since there are at least two such camera/known-point lines D1′, D2′ (corresponding to known points P1 and P2), it is possible to resolve the location of image sensor 110 as the intersection of lines D1′, D2′ with previously established circle 410. Put another way, solving for the intersection of camera/known-point lines D1′, D2′ and circle 410 yields the location of the camera in three-dimensional space.

### 5. Determining the Angle of Incidence of Light on the Image Sensor Backplane

As discussed above, in an exemplary embodiment, the method of the present invention may require the determination of the angle of incidence, on backplane or imaging element 205 of image sensor 110, of the light D1, D2, etc., incident on backplane 205 from a CPS 120.

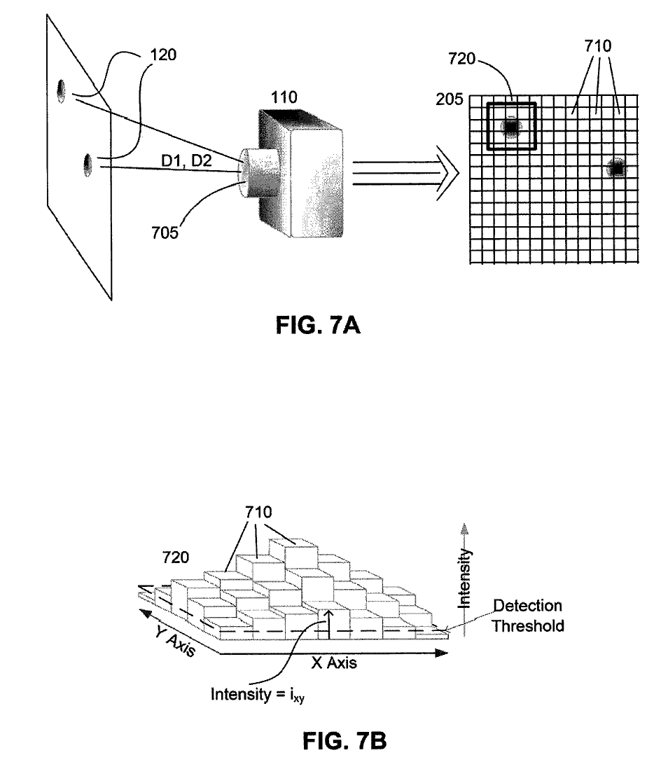

FIG. 7A and FIG. 7B together illustrate an method for locating a CPS 120 in an image sensor 110 field of view, and hence for identifying an angle α or pair of angles (α1, α2), where α represents an angle of incidence of a ray of light D1, D2, etc., from a CPS 120 onto backplane 205 of image sensor 110.

FIG. 7A illustrates image sensor 110 observing two CPSs 120, with rays of light D1, D2 from CPSs 120 striking a lens or other optical element 705 of image sensor 110. The lens or other optical elements 705, possibly in combination with other internal optical elements (not shown) focuses rays of light D1, D2 from CPSs 120 onto backplane 205 (i.e., the imaging element) of image sensor 110. The backplane 205 is here represented as a matrix of discrete pixel elements 710 (i.e., sensor cells), which may be physical pixel elements, or which may be logical pixel elements derived from a scanning process or similar process which extracts image information from a continuous light sensitive media of backplane 205. Together, discrete pixel elements 710 comprise a digitized field of view of CPSs 120 within the field of view of image sensor 110. Each CPS 120 light source may be perceived by image sensor 110 as a heightened area of sensed light intensity in a bounded area 720 of the digitized field of view.

FIG. 7B illustrates how different pixel elements or sensor cells 710 in the bounded area of detection 720 may detect different degrees of light intensity. In the figure, the light intensity is exemplified by the height of a pixel element 710. (The “height” is representational only, corresponding to a recorded light intensity, and does not correspond to a physical, structural height of a pixel in a physical backplane or imaging element.) Pixel element 710 may only be considered to have detected light from a CPS 120 if the measure of light intensity from the pixel element 710 exceeds a threshold value.

The coordinate location, such as for example an X-coordinate and a Y-coordinate, of a pixel element 710 which is illuminated by light from a CPS 120 may be considered a first parameter or first set of parameters pertaining to the incidence on the imaging element 205 of light from CPS 120. Persons skilled in the relevant arts will recognize that the use of an orthogonal X-Y coordinate system is exemplary only, and other coordinate systems may be used as well. The intensity of light received by a pixel element 710 from a CPS 120 may be considered a second parameter pertaining to the incidence on the imaging element 205 of light from CPS 120.

The parameters pertaining to the incidence on the imaging element 205 of light from CPS 120 may be used to compute a centroid (i.e., a region of image location) of the light from CPS 120. The pixel elements or sensor cells 710 used to compute the centroid are separated by their amplitude, grouping, and group dimensions. In an exemplary calculation, the center of a CPS 120 image on backplane 205 is located by finding the optical centroid (X_{C}, Y_{C}) of the CPS 120 light source, using the equations:

X_{C}=(ΣI_{XY}*X_{XY})/ΣI_{XY}

Y_{C}=(ΣI_{XY}*Y_{XY})/ΣI_{XY}

where I_{XY} is the measured light intensity of a pixel element 710 within the area of detection 720, X_{XY} is the X-coordinate of the pixel element 710 relative to the area of detection 720, and Y_{XY} is the Y-coordinate of the pixel element 710 relative to the area of detection 720. Persons skilled in the relevant arts will recognize that additional X-Y coordinates, or other coordinate parameters, may be used to locate area of detection 720 in relation to an overall coordinate origin of backplane 205 taken as a whole.

Corrections may be applied to the computation of this centroid. The first of these corrections is a temperature based offset of intensity amplitude on a per cell basis. The second compensation is the exact X:Y location of each cell based on corrections for errors in the optics inherent in image sensor 110. These corrections are applied locally prior to the centroid computation being made for each CPS centroid.

Once a determination has been made of the XY-position of the centroid, the offset angles (α1, α2) from the center of the backplane 205 field of view at which rays of light from the CPS 110 impinge on the backplane 205 can be readily determined using calculations which are well-known in the art. So, for example, the angles α and β illustrated in FIG. 3, which represent angles of incidence of rays of light D1, D2 from CPSs 120 relative to the backplane 205, may be calculated according to the method described here.

In one embodiment of the present invention, the calculations described above may be performed by image sensor 110. In another embodiment of the present invention the calculations may be performed by DAE 150.

### 6. Eliminating Skew Errors

The methods and calculations described above for determining an orientation and location of an image sensor in an arena are subject to a number of factors which may introduce error into the calculations. As already indicated, errors may occur in determining the angle of incidence of a ray of light D1, D2, etc., on the backplane 205 of an image sensor 110, due to inherent internal sources of error. Methods for compensating for these errors have already been indicated above.

Additional sources of error may occur due to uncertainties in the detection of the angular orientation of an image sensor 110 via a PMD 210, since a PMD may be subject to an error margin. Still other measurement errors may occur due to the electrical noise and other error-inducing factors inherent in any electrical system.

A number of means may be employed to limit the degree of error. In particular, since electrical noise and other measurement errors may tend to be random in nature, the method and calculations described above, or analogous methods and calculations, may be repeated several times. In particular, measurements of the angular orientation of the image sensor 10 may be repeated several times, each time with a corresponding measurement or set of measurements of the angle(s) of incidence of light from a CPS 120 on an image sensor 110. The foregoing calculations may then be repeated for each set of measurements, yielding several different results for the position of the image sensor.

Various averaging algorithms or curve-fitting methods, well-known in the art, may then be applied to the set of resulting positions; in this way, a most-likely position or highest probability position, along with a standard-deviation or other measure of error spread, may be determined.

7. Visual Tracking Systems with Two or More Cameras

In visual tracking systems where two or more image sensors 110 are used, essentially the same methods as those indicated above may be used to determine the location of each image sensor. However, the image sensors 110 may not only have an attached or integrated PMD, but in addition each image sensor 110 may also have an integrated light source. That is, each sensor may have an integrated CPS 120, where the light emitting element is somewhere on one of the external, visible surfaces of image sensor 110, so that it may serve as a reference light source for other image sensors 110 during the calibration process. An image sensor 110 with an integrated CPS 120 may be referred to as a CPS-enhanced sensor, or as a CPSES for short, the plural being “CPSESs”.

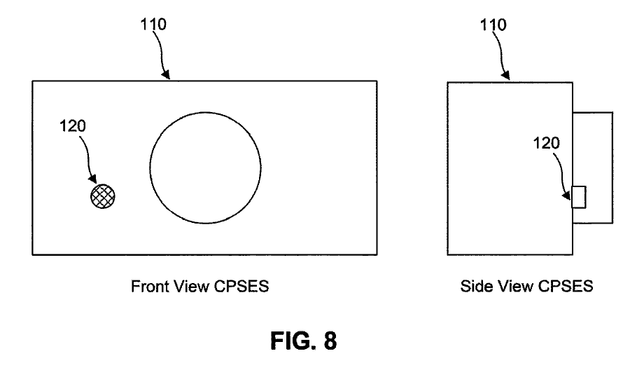

FIG. 8 shows representative front and side views of an image sensor 110 with a front mounted CPS 120. In an exemplary embodiment, a number of CPSESs 110 may be placed in the arena 100 in such a way that their locations may be well-established. For example, they may be placed at fixed locations on exterior walls, or at other locations where their coordinates can be measured easily, accurately, and precisely in relation to the arena coordinate system 105, using mechanical or other measuring methods discussed above. Similarly, they may be placed in such a way that their angle of orientation can be readily determined using simple and conventional tools.

The CPSESs 110 may also be designed so that the location of the point light source 120 on the body of the image sensor 110 itself is at a clearly defined location. For example, a CPSES 110 with a point light source 120 on the front panel of the image sensor 110 may be designed to be exactly three inches thick, and with the point light source 120 placed exactly one inch horizontally and one inch vertically from a specific front corner of the image sensor 110. In this way, the exact location of the point light source 120 can be readily determined, based on a carefully measured location of the CPSES 110 itself.

The CPSESs 110 which have been placed at carefully measured locations within the simulation arena 100 may now serve as light sources 120 for the calibration of other image sensors 110 which may be placed elsewhere within the simulation arena. These other image sensors 110 may then calibrate their own locations using the methods described above, and using the CPSESs 110 as calibration light sources. In addition, if a sufficient number of CPSESs 110 have been placed at points around the simulation arena, and placed in such a way that any one CPSES 110 has at least two other CPSESs 110 in its field of view, then each CPSES 110 may further calibrate its own location in the manner described above. This may serve to check and to validate any initial manual measurements which have been made of CPSES 110 location.

### 8. Image Sensors, the Arena Data Analysis Engine, and Data Processing Elements

The system and method described above for calibrating the orientation and location of image sensors 110 in an arena 100 depends on calculations which include, for example and without limitation, determining the distance D from an image sensor 110 to a calibration point source 120, and/or determining an equation of a line connecting an image sensor 110 to a calibration point source 120. In various alternative embodiments of the present invention, other calculations or alternative calculations may be required as well.

Some or all of these calculations may be performed by microprocessors or dedicated analysis hardware, software, or firmware or a combination thereof on board the image sensors 110. Alternatively, some or all of these calculations may be performed by an external processing mechanism, such as an arena data analysis engine (DAE) 150 or analogous computational system to which the image sensors 110 offload data via a network or other means. Alternatively, the required computational tasks may be divided in a number of ways between processing which is onboard image sensors 110 and an external processing mechanism such as a DAE 150.

In one embodiment, therefore, the present system and method is directed toward one or more computer systems capable of carrying out the functionality described herein. In another embodiment, therefore, the present system and method is directed toward a computer program or software configured to execute the present system and method on one or more computer systems.

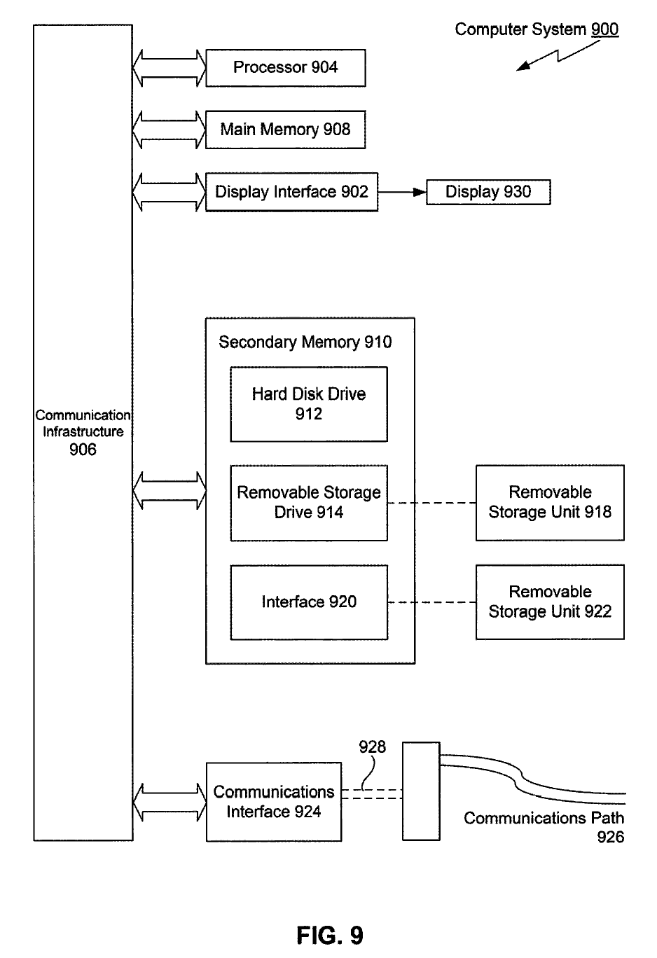

An exemplary computer system 900 configured to run software suitable for the present system and method is shown in FIG. 9.

Exemplary computer system 900 contains elements which may typically be associated with a dedicated computational system, such as for example DAE 150. Some elements shown in FIG. 9 may not be present or may not be required for processing which occurs onboard the image sensors 110 of the present system and method. However, persons skilled in the relevant arts will recognize that many of the elements shown in FIG. 9 would likely be included in a processing system which may be implemented as part of or in association with image sensors 110. Such elements may include, but not be limited to processor 904, main memory 908, some or all elements of secondary memory 910, communications infrastructure 906, and communications elements 924, 928. All of these elements are described in further detail below.

Further, if an image sensor 110 incorporates some or all of such computation-associated elements as processor 904, memory 908, 910, communications infrastructure 906, communications elements 924, 928, and possibly other elements which support or which are associated with computational tasks, then image sensor 110 may also be understood to be configured to operate at least in part as a computational device or as a computer. An image sensor 110 which is configured to operate as a computer, and in which the computational elements (such as, for example, processor 904) are operating under the control of suitable instructions (which may be provided, for example, as software or firmware) may be understood to be operating at least in part as a computational device or as a computer.

Whether implemented as part of a DAE 150 or other computer associated with arena 100, or as part of an image sensor 110 which may also be configured to operate in part as a computer, some or all of the elements illustrated in FIG. 9 may be employed to perform the exemplary calculations disclosed above, or similar calculations within the spirit and scope of the present system and method. These elements, illustrated in FIG. 9, are discussed further below. The discussion below refers to a “computer system 900”, but it should be understand, as already described above, that the discussion is equally applicable to computational elements such as a processor 904 or memory 908, 910 which may be found onboard an image sensor 110 configured to operate in part as a computer.

The computer system 900 includes one or more processors, such as processor 904. Processor 904, if associated with DAE 150 of arena 100 or if associated with another computer or server which supports a simulation in arena 100, may also be considered or viewed as a “processor of the simulation environment”, or a “processor of a computer of the simulation environment.” The processor 904 is connected to a communication infrastructure 906 (for example, a communications bus, cross over bar, or network). Computer system 900 can include a display interface 902 that forwards graphics, text, and other data from the communication infrastructure 906 (or from a frame buffer not shown) for display on the display unit 930.

Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well known manner. Removable storage unit 918 represents a floppy disk, magnetic tape, optical disk (for example, a CD or DVD), etc. which is read by and written to by removable storage drive 914. As will be appreciated, the removable storage unit 918 includes a computer usable storage medium having stored therein computer software and/or data.

In alternative embodiments, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), programmable read only memory (PROM)) and associated socket, a flash drive which is typically connected via a USB port, IEEE 1394 (FireWire) port or other flash memory port, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port such as a USB port, FireWire port, serial port, parallel port, a Personal Computer Memory Card International Association (PCMCIA) slot and card, etc. Software and data transferred via communications interface 924 are in the form of signals 928 which may be electronic, electromagnetic, optical or other signals capable of being received by communications interface 924. These signals 928 are provided to communications interface 924 via a communications path (e.g., channel) 926. This channel 926 carries signals 928 and may be implemented using wire or cable, fiber optics, a telephone line, a cellular link, an radio frequency (RF) link, an infrared link and other communications channels. In an embodiment, communications interface 924 and communications channel 926 are separate from communication infrastructure 906. In an alternative embodiment, communications interface 924 and communications channel 926 are elements of or components of communication infrastructure 924.

In this document, the terms “computer program medium” and “computer usable medium” are used to generally refer to media such as removable storage drive 914 and/or associated removable storage unit 918, a hard disk installed in hard disk drive 912, other removable storage interface 920 and/or removable storage unit 922, and signals 928. These computer program products provide software to computer system 900. An embodiment of the invention is directed to such computer program products.

Computer programs (also referred to as “software” or “computer control logic”) are stored in main memory 908, secondary memory 910, and/or associated removable storage 918, 922. Computer programs may also be received via communications interface 924. Such computer programs, when executed, enable the computer system 900 to perform the features of the present system and method, as discussed herein. In particular, the computer programs, when executed, enable the processor 904 to perform the features of the present system and method. Accordingly, such computer programs represent controllers of the computer system 900.

In an embodiment where the invention is implemented using a computer program or programs, the computer program(s) may be stored in a computer program product and loaded into computer system 900 using removable storage drive 914, hard drive 912, other removable storage interface 920, and/or communications interface 924. The control logic (software), when executed by the processor 904, causes the processor 904 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

The software associated will the present system and method is configured to perform calculations the same as, similar to, analogous to, or substantially analogous or similar to the exemplary calculations disclosed above for determining the location, orientation, and/or position of an image sensor 110 or image sensors 110 in an arena 100. The software may perform related functions as well. For example, the software may provide for user interface features. The user interface features may for example provide an interface which enables a user of the present system and method to initiate a position-determining process, to configure parameters associated with a position determining process, or to view or download position data obtained through the process. Other control, configuration, and data retrieval or data processing operations associated with the present system and method may be implemented through the software as well. For example, the software may enable a user to control a variety of parameters associated with the control or operation of images sensors 110. The software may also enable a user to configure signal modulation patterns for CPSs 120. Such configuration may be done directly to CPSs 120, and/or may also be done to enable image sensors 110 to determine which CPSs 120 are within their field of view.

It should be noted that aspects of the processing required for the present system and method may be performed primarily via a processor 904 and memory 908, 910 associated with image sensor(s) 110; or primarily via a processor 904 and memory 908, 910 associated with DAE 150; or may be distributed across processors 904 and memory 908, 910 associated with sensor(s) 110 and DAE 150. In addition, CPSs 120 may also have a processor 904 and memory 908, 910 to store and control the modulation pattern of light emitted by CPSs 120.

In an exemplary embodiment, calculations of a centroid (i.e., a region of image location) of the light from CPS 120 onto backplane 205 of image sensor 110 may be performed by image sensor 110. Calculations of angles of incidence of the light from CPS 120 onto backplane 205 of image sensor 110 may be performed by image sensor 110 or by DAE 150. Further calculations to derive a location or position of image sensor 110 in arena 100 may be performed by DAE 150 or other computer system associated with arena 100. In alternative embodiments, the requisite calculation tasks may be apportioned differently between a processor or processors associated with image sensor(s) 100 and DAE 150.

Persons skilled in the relevant arts will recognize that image sensor(s) 110 and DAE 150 may exchange necessary data via respective communications elements 924, 926, 928 associated with image sensor(s) 110 and DAE 150. Such communications elements 924, 926, 928 may comprise, for example, an Ethernet network link, USB or FireWire connections, radio frequency links, infrared links, or similar links. Persons skilled in the relevant arts will also recognize that appropriate processing instructions may be uploaded into a memory 908, 910 of image sensor(s) 110 via a variety of means, including removable storage 918, 922 or via communications elements 924, 926, 928.

### 9. Summary

While some embodiments of the present invention have been described above, it should be understood that it has been presented by way of examples only and not meant to limit the invention. It will be understood by those skilled in the relevant art(s) that various changes in form and detail may be made therein without departing from the spirit and scope of the invention as defined in accordance with the claims listed below. Thus, the breadth and scope of the present invention should not be limited by any of the above described exemplary embodiments, but should be defined only in accordance with the following claims and their equivalents.

In addition, it should be understood that the figures and illustrated in the attachments, which highlight the functionality and advantages of the present invention, are presented for example purposes only. The architecture of the present invention is sufficiently flexible and configurable, such that it may be utilized and implemented in ways other than that shown in the accompanying figures.

What is claimed is:

1. In a simulation environment having a coordinate system, the simulation environment including an image sensor, and a plurality of point sources of light each at a respective fixed and identified location in relation to the coordinate system, a method of determining a position of the image sensor, comprising:
(a) determining an angular orientation of the image sensor in relation to the coordinate system;
(b) determining a plurality of respective distances from the image sensor to the plurality of point sources of light; and
(c) calculating a position of the image sensor in relation to the coordinate system based on the angular orientation and the plurality of respective distances.

2. The method of claim 1, wherein step (a) comprises determining the angular orientation via an angular orientation determining element associated with the image sensor.

3. The method of claim 2, wherein determining the angular orientation via the angular orientation determining element comprises determining the angular orientation via at least one of an accelerometer, a magnetometer, or a gyroscope associated with the image sensor.

4. The method of claim 1, wherein step (b) comprises determining respective angles of incidence of light from the plurality of point source of light at the image sensor.

5. The method of claim 4, wherein step (b) further comprises performing a distance calculation based on:
the respective angles of incidence; and
a distance between at least a pair of point sources of light of the plurality of point sources of light.

6. The method of claim 5, wherein the step of performing a distance calculation further comprises determining the distance between the at least a pair of point sources of light based on the respective fixed and identified location in relation to the coordinate system of each point source of light of the at least a pair of point sources of light.

7. The method of claim 1, wherein the image sensor comprises a stereoscopic image sensor; and
step (b) comprises performing a distance calculation based on a stereoscopic imaging of the plurality of point sources of light.

8. The method of claim 1, wherein step (c) comprises:
(i) determining equations which define a plurality of spheres, wherein each sphere of the plurality of spheres is centered at a coordinate location of a respective point source of light of the plurality of point sources of light, and wherein each sphere has a respective radius equal to a respective distance from the image sensor to the respective point sources of light.

9. The method of claim 8, wherein step (c) further comprises:
(ii) determining an intersection of the spheres, wherein the intersection comprises at least one of a circle, a set of points, or a point.

10. The method of claim 9, wherein step (c) further comprises:
(iii) calculating the position based on the point of intersection of the spheres.

11. The method of claim 9, wherein step (c) further comprises:
(iii) determining an equation of a line from the image sensor to a point source of light of the plurality of point sources.

12. The method of claim 11, wherein determining the equation of the line from the image sensor to the point source of light comprises determining the equation of the line based on:
the respective fixed and identified location of the point source in relation to the coordinate system;
the angular orientation of the image sensor in relation to the coordinate system and
an angle of incidence of light from the point source of light at the image sensor.

13. The method of claim 11, wherein step (c) further comprises:
(iv) calculating an intersection of the line with the intersection of the spheres.

14. In a simulation environment having a coordinate system, an image sensor location determination system comprising:
an image sensor;
a plurality of point sources of light each at a respective fixed and identified location in relation to the coordinate system;
at least a processor; and
a memory in communication with the at least a processor;
wherein:
the image sensor is configured to determine an orientation of the image sensor in relation to the coordinate system; and
the memory stores a plurality of processing instructions for directing the at least a processor to determine a position of the image sensor in relation to the coordinate system based on:
the orientation of the image sensor; and
a plurality of respective distances from the image sensor to the plurality of point sources of light.

15. The system of claim 14, wherein the at least a processor comprises at least one of a processor of the image sensor or a processor of a computer of the simulation environment.

16. The system of claim 14, further comprising an angular orientation determining element associated with the image sensor, the angular orientation determining element configured to determine the orientation of the image sensor in relation to the coordinate system.

17. The system of claim 16, wherein the angular orientation determining element comprises at least one of an accelerometer, a magnetometer, or a gyroscope associated with the image sensor.

18. The system of claim 14, wherein the instructions for directing the at least a processor to determine the location of the image sensor comprise instructions to determine the plurality of respective distances from the image sensor to the plurality of point sources of light.

19. The system of claim 18, wherein the instructions for directing the at least a processor to determine the plurality of respective distances comprise instructions to calculate the plurality of respective distances based on the respective fixed and identified locations in relation to the coordinate system of the plurality of point sources of light.

20. The system of claim 18, wherein the instructions for directing the at least a processor to determine the plurality of respective distances comprise instructions to calculate the plurality of respective distances based on the orientation of the image sensor in relation to the coordinate system.

21. The system of claim 18, wherein the instructions for directing the at least a processor to determine the plurality of respective distances comprise instructions to calculate the plurality of respective distances based on a plurality of respective angles of incidence at the image sensor of light from the plurality of point sources.

22. The system of claim 21, wherein:
the image sensor is configured to detect an incidence of light from the plurality of point sources of light; and
the instructions for directing the at least a processor to determine the plurality of respective distances further comprise instructions to determine the plurality of respective angles of incidence at the image sensor of light from the plurality of point sources based on the detected incidence of light from the plurality of point sources.

23. The system of claim 21, wherein:
the image sensor further comprises an imaging element; and
the instructions for directing the at least a processor to determine the plurality of respective angles of incidence at the image sensor of light from the plurality of point sources comprise instructions to determine the plurality of respective angles of incidence based on at least one of:
a location on the imaging element of a ray of light; or
an intensity at the imaging element of the ray of light.

24. The system of claim 18, wherein:
the image sensor further comprises a stereoscopic image sensor; and
the instructions for directing the at least a processor to determine the plurality of respective distances comprise instructions to determine a distance based on a stereoscopic imaging of the plurality of point sources.

25. The system of claim 14, wherein the instructions for directing the at least a processor to determine the position of the image sensor in relation to the coordinate system further comprise instructions to determine equations which define a plurality of spheres, wherein:
each sphere of the plurality of spheres is centered around a respective point source of light of the plurality of point sources; and
each sphere has a respective radius equal to the respective distances from the image sensor to the respective point sources of light.

26. The system of claim 25, wherein the instructions for directing the at least a processor to determine the position of the image sensor in relation to the coordinate system further comprise instructions to determine an intersection of the spheres, wherein the intersection comprises at least one of a circle, a set of points, or a point.

27. The system of claim 26, wherein the instructions for directing the at least a processor to determine the position of the image sensor in relation to the coordinate system further comprise instructions to calculate the position based on the point of intersection of the spheres.

28. The system of claim 26, wherein the instructions for directing the at least a processor to determine the position of the image sensor in relation to the coordinate system further comprise instructions to determine an equation of a line from the image sensor to a point source of light of the plurality of point sources.

29. The system of claim 28, wherein the instructions for directing the at least a processor to determine the equation of a line from the image sensor to the point source of light further comprise instructions to determine the equation of the line based on:
the respective fixed and identified location of the point source in relation to the coordinate system;
the angular orientation of the image sensor in relation to the coordinate system and
an angle of incidence of light from the point source of light at the image sensor.

30. The system of claim 28, wherein the instructions for directing the at least a processor to determine the position of the image sensor in relation to the coordinate system further comprise instructions to determine an intersection of the line with the intersection of the spheres.

31. A computer program product comprising a computer usable medium having control logic stored therein for causing the computer to determine a position of an image sensor in relation to a coordinate system of a simulation environment, the control logic comprising:
first computer readable program code means for causing the computer to receive for a plurality of point sources of light of the simulation environment a plurality of respective fixed and identified locations of the point sources in relation to the coordinate system;
second computer readable program code means for causing the computer to determine the angular orientation of the image sensor in relation to the coordinate system;
third computer readable program code means for causing the computer to calculate a plurality of respective distances from the image sensor to the plurality of point sources of light; and
fourth computer readable program code means for causing the computer to calculate the position of the image sensor in relation to the coordinate system based on the angular orientation and the plurality of respective distances.

32. The computer program product of claim 31, wherein said second computer readable program code means for causing the computer to determine the angular orientation of the image sensor comprises:
computer readable program code means for causing the computer to determine the angular orientation of the image sensor based on an angular orientation data received from an angular orientation measuring element associated with the image sensor.

33. The computer program product of claim 32, wherein said second computer readable program code means for causing the computer to determine the angular orientation of the image sensor further comprises:
computer readable program code means for causing the computer to receive the angular orientation data from at least one of an accelerometer, a magnetometer, or a gyroscope associated with the image sensor.

34. The computer program product of claim 31, wherein said third computer readable program code means for causing the computer to calculate the plurality of respective distances from the image sensor to the plurality of point sources of light comprises:
computer readable program code means for causing the computer to calculate the plurality of respective distances based on the plurality of respective fixed and identified locations of the point sources in relation to the coordinate system.

35. The computer program product of claim 31, wherein said third computer readable program code means for causing the computer to calculate the plurality of respective distances from the image sensor to the plurality of point sources of light comprises:
computer readable program code means for causing the computer to calculate the plurality of respective distances based on the angular orientation of the image sensor in relation to the coordinate system.

36. The computer program product of claim 31, wherein said third computer readable program code means for causing the computer to calculate the plurality of respective distances from the image sensor to the plurality of point sources of light comprises:
(i) computer readable program code means for causing the computer to calculate the plurality of respective distances based on a plurality of respective angles of incidence at the image sensor of light from the plurality of point sources.

37. The computer program product of claim 36, wherein said computer readable program code means for causing the computer to calculate the plurality of respective distances based on a plurality of respective angles of incidence at the image sensor of light from the plurality of point sources comprises:
(i)(a) computer readable program code means for causing the computer to receive from the image sensor a plurality of detected incidences of light from the plurality of point sources detected by the image sensor.

38. The computer program product of claim 37, wherein a detected incidence of light comprises at least one of a location on an imaging element of the image sensor of a ray of light or an intensity at the imaging element of the ray of light; and
wherein said computer readable program code means for causing the computer to calculate the plurality of respective distances based on the plurality of respective angles of incidence at the image sensor of light from the plurality of point sources further comprises:
(i)(b) computer readable program code means for causing the computer to calculate the plurality of respective angles of incidence based on at least one of:
the location on the imaging element of the image sensor of the ray of light; or
the intensity at the imaging element of the ray of light.

39. The computer program product of claim 31, wherein said third computer readable program code means for causing the computer to calculate the plurality of respective distances from the image sensor to the plurality of point sources of light further comprises:
computer readable program code means for causing the computer to calculate the plurality of respective distances based on a stereoscopic imaging data of the plurality of point sources by an image sensor configured as a stereoscopic image sensor.

40. The computer program product of claim 31, wherein said fourth computer readable program code means for causing the computer to calculate the position of the image sensor based on the angular orientation and the plurality of respective distances comprises:
(i) computer readable program code means for causing the computer to determine equations which define a plurality of spheres, wherein:
each sphere of the plurality of spheres is centered around a coordinate location of a respective point source of light of the plurality of point sources; and
each sphere has a respective radius equal to the respective distances from the image sensor to the respective point sources of light.

41. The computer program product of claim 40, wherein said fourth computer readable program code means for causing the computer to calculate the position of the image sensor based on the angular orientation and the plurality of respective distances further comprises:
(ii) computer readable program code means for causing the computer to calculate an intersection of the spheres, wherein the intersection comprises at least one of a circle, a set of points, or a point.

42. The computer program product of claim 41, wherein said fourth computer readable program code means for causing the computer to calculate the position of the image sensor based on the angular orientation and the plurality of respective distances further comprises:
(iii) computer readable program code means for causing the computer to determine the position of the image sensor in relation to the coordinate system based on the point of intersection of the spheres.

43. The computer program product of claim 41, wherein said fourth computer readable program code means for causing the computer to calculate the position of the image sensor based on the angular orientation and the plurality of respective distances further comprises:
(iii) computer readable program code means for causing the computer to calculate an equation of a line from the image sensor to a point source of light of the plurality of point sources.

44. The computer program product of claim 43, wherein said computer readable program code means for causing the computer to calculate the equation of the line comprises:
(iv) computer readable program code means for causing the computer to calculate the equation of the line based on:
the respective fixed and identified location of the point source in relation to the coordinate system;
the angular orientation of the image sensor in relation to the coordinate system and
an angle of incidence of light from the point source of light at the image sensor.

45. The computer program product of claim 43, wherein said fourth computer readable program code means for causing the computer to calculate the position of the image sensor based on the angular orientation and the plurality of respective distances further comprises:
(iv) computer readable program code means for causing the computer to calculate an intersection of the line with the intersection of the spheres.
